(19) United States
(12) Patent Application Publication
(10) Pub. No.: US 2002/0082883 A1
(43) Pub. Date: Jun. 27, 2002

(54) Method and system for implementing a project in an organization

(76) Inventor: Robert C. Hankinson, Tacoma, WA (US)

Correspondence Address: David G. Wille, Baker Botts L.L.P., 2001 Ross Avenue, Dallas, TX, 75201, US

(21) Appl. No.: 09/747,494

(22) Filed: Dec. 22, 2000

(51) Int. Cl. G06F 17/60

(52) U.S. Cl. 705/7

(57) ABSTRACT

A method for implementing a project in an organization is disclosed. A contract (44) representing an agreement between an organization (10) and a project owner (114) is received, where the agreement is associated with implementing a project, and is stored in a project file (52) of a database (40). A monitoring report describing execution of the project in accordance with the contract (44) is received and stored in the database (40). A corrective action request generated in response to the monitoring report and including a request to penalize the project owner (114) is received. The project file (52) is modified in response to the corrective action request to indicate that the project is not executing. A corrective action is initiated in accordance with the corrective action request.

### TECHNICAL FIELD OF THE INVENTION

This invention relates generally to the field of management systems and more specifically to a method and system for implementing a project in an organization.

### BACKGROUND OF THE INVENTION

Organizations such as companies typically require a number of individuals to undertake and complete projects to further the goals of the organization. The individuals undertaking the project, however, are often not motivated to satisfactorily complete a project. As a result, projects are often over-budget or behind schedule, and sometimes are not even completed. Consequently, implementing projects has posed challenges for organizations.

### SUMMARY OF THE INVENTION

While known approaches have provided improvements over prior approaches, the challenges in the field of management systems have continued to increase with demands for more and better techniques having greater efficiently and effectiveness. Therefore, a need has arisen for a new method and system for implementing a project in an organization.

In accordance with the present invention, a method and system for implementing a project in an organization are provided that substantially eliminate or reduce the disadvantages and problems associated with previously developed systems and methods.

According to one embodiment of the present invention, method for implementing a project in an organization is disclosed. A contract representing an agreement between an organization and a project owner is received. The agreement is associated with implementing a project. The contract is stored in a project file of a database. A monitoring report describing execution of the project in accordance with the contract is received and is stored in the database. A corrective action request generated in response to the monitoring report is received. The corrective action request includes a request to penalize the project owner. The project file is modified in response to the corrective action request to indicate that the project is not executing. A corrective action is initiated in accordance with the corrective action request.

According to another embodiment of the present invention, a system for implementing a project in an organization is disclosed. A database stores data. A processing manager receives a contract representing an agreement between an organization and a project owner, where the agreement is associated with implementing a project, and stores the contract in a project file of the database. The processing manager receives a monitoring report describing execution of the project in accordance with the contract, and stores the monitoring report in the database. The processing manager receives a corrective action request generated in response to the monitoring report, where the corrective action request includes a request to penalize the project owner. The processing manager modifies the project file in response to the corrective action request to indicate that the project is not executing, and initiates a corrective action in accordance with the corrective action request.

According to another embodiment of the present invention, a method for implementing a project in an organization is disclosed. A project associated with a project owner is defined. A contract between an organization and the project owner is generated, where the contract is associated with implementing the project. Execution of the project is monitored. Whether the execution is in compliance with the contract is determined in response to the monitoring. A corrective action is determined if the execution is not in compliance with the contract, where the corrective action includes penalizing the project owner.

Embodiments of the invention may provide numerous technical advantages. A technical advantage of one embodiment is that a contract is made between an organization and a project owner, whereby the project owner accepts responsibility for implementation of a project. The contract may include a budget and a schedule according to which the project must be implemented. The contract may also include a benefit realization plan that describes the benefits that the project is expected to deliver. The contract encourages the project owner to execute the project in a satisfactory manner.

A technical advantage of another embodiment is that execution of the project is monitored by a project reviewer. The project reviewer determines whether the project is being executed according to the budget and schedule, and is satisfying the benefit realization plan. A technical advantage of another embodiment is that the project owner may be penalized if execution of the project is not in compliance with the contract. Threat of a penalty may encourage the project owner to satisfactorily execute the project.

A technical advantage of another embodiment is that a database electronically records the development and execution of the project. The database record may allow an organization to analyze how it implements projects. Additionally, the database record documents the reasons for penalizing a project owner.

Other technical advantages are readily apparent to one skilled in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 is a block diagram of one embodiment of a system that may be used in accordance with the present invention;

FIG. 2 is a flowchart illustrating one embodiment of a method that may be used in accordance with the present invention; and

FIG. 3 is a flowchart illustrating another embodiment of a method that may be used in accordance with the present invention.

### DETAILED DESCRIPTION OF THE DRAWINGS

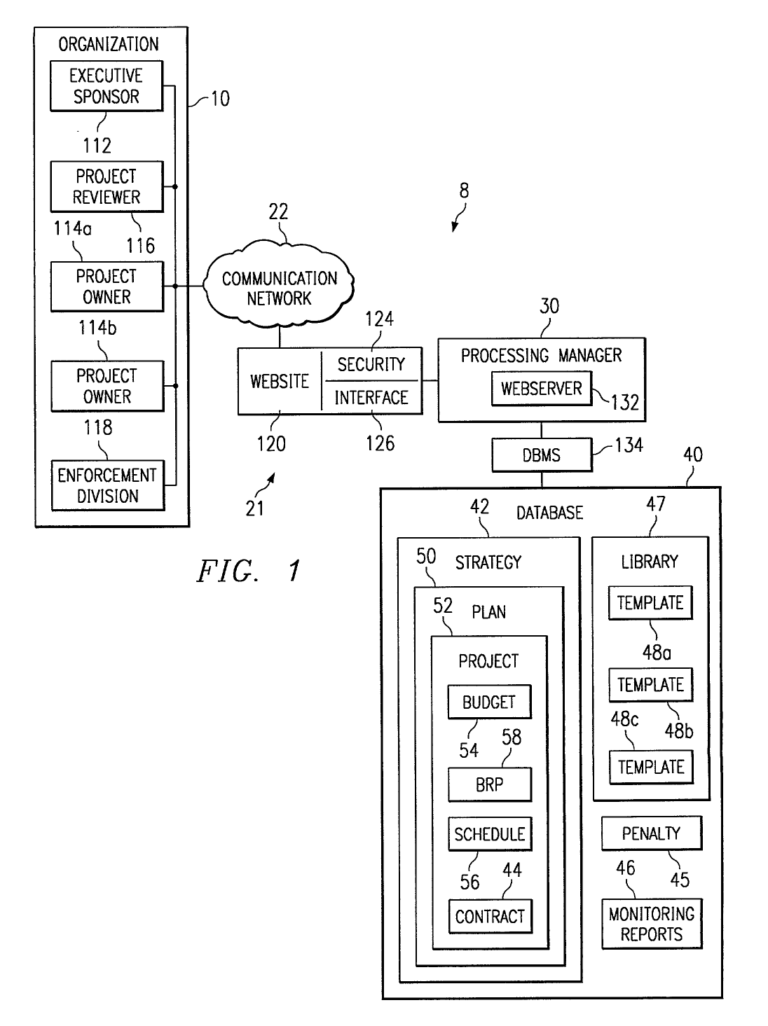

Embodiments of the present invention and its advantages are best understood by referring to FIGS. 1 through 3 of the drawings, like numerals being used for like and corresponding parts of the various drawings.

FIG. 1 is a block diagram of one embodiment of a system 8 for implementing a project in an organization. According to the depicted embodiment, a project owner enters into an internal contract with an organization, whereby the project owner agrees to take responsibility for implementing a project according to a budget and schedule, while satisfying a benefit realization plan. A project reviewer of the organization monitors execution of the project to determine compliance with the contract. If execution of the project is not in compliance with the contract, an executive sponsor of the organization perform a corrective action, which may include penalizing the project owner. A database electronically records the development and execution of the project, and provides a record of reasons for penalizing the project owner. Consequently, system 8 may provide for an effective and efficient manner for implementing a project in an organization.

Referring to FIG. 1, system 8 may comprise an organization 10, a communications network 22 coupled to organization 10, a website module 21 coupled to communications network 22, a processing manager 30 coupled to website module 21, and a database 40 coupled to processing manager 30.

Database 40 records the development and implementation of a project. Database 40 includes a strategy file 42, a contract 44, monitoring reports 46, and a library 47 of templates 48. Strategy file 42 describes a strategy of organization 10, which may include goals that organization 10 wants to accomplish and potential projects that organization 10 may wish to undertake. The determination of a unified strategy may enable organization 10 to eliminate duplicative projects that accomplish the same goals, ensure alignment of a project with organizational goals, and determine budget and scheduling requirements for projects.

Strategy file 42 includes a plan file 50, which in turn includes a project file 52. Plan file 50 describes plans that may include projects that organization 10 has decided to undertake. Project file 52 describes projects that are used to implement a plan of plan file 50. A project may, for example, describe an undertaking by organization 10 to develop and/or maintain a product or service. A project may include processes that describe activities needed to complete the undertaking. Processes may also specify how to handle exception conditions and to record execution of the project.

Project file 52 includes a budget 54, a schedule 56, a business realization plan (BRP) 58, and a contract 44. Budget 54 specifies the funding allotted for implementation of a project. Budget 54 may take into account project expenses such as expenses for salaries, office support and maintenance, and travel. Budget 54 may be aligned with other budgets such as budgets for other projects or for organization 10 as a whole, in order to allow for the availability of funds sufficient to complete projects and to operate organization 10.

Schedule 56 defines the timeline and milestones for the completion of a project. Schedule 56 of a project may be aligned with schedules of other projects that depend on the timely execution of the project. A delay of a project with dependent projects may be regarded as more costly than a delay of a project without dependent projects. Budget 54 and schedule 56 may include predefined tolerance ranges within which the execution of a project must fall in order to be considered in compliance with the contract.

Benefit realization plan 58 describes the benefits that a project must deliver and the costs expected to be incurred by the project. Benefits may be measurable in order to enable effective monitoring of the project. Benefits may be described as tangible or intangible. Tangible benefits may include financial benefits such as completing a project within or under budget 54. These benefits may be realized by an increase in efficiency or effectiveness that result in a decrease in costs without loss of revenue.

Intangible benefits may include non-financial benefits that cannot be directly translated into financial benefits, but still have value to organization 10. An intangible benefit may include improved staff morale, which may be measured by an employee satisfaction survey. The benefits of benefit realization plan 58 may include predefined tolerance ranges within which the execution of a project must fall in order to be considered in compliance with the contract.

Costs may include expenses taken into account by budget 54. Costs may also include absorbed costs and opportunity costs. Absorbed costs include costs that come from managing the project but are not included in budget 54, such as expenses associated with monitoring and evaluating the project. Opportunity costs include the value that could have been obtained from the resources of the project if the project had not been implemented.

A contract 44 may describe an internal agreement between organization 10 and project owner 114 to implement a project. Contract 44 may simply state that project owner 114 is responsible for implementing project 52 in accordance with budget 54 and schedule 56, while satisfying benefit realization plan 58. Contract 44 may include attached documents that provide details about the projects. Monitoring reports 46 describe the results of monitoring the execution of a project. A penalty file 45 documents a penalty assessed against project owner 114 and reasons for the penalty. A library 47 of templates 48 may be used by processing manager 30 to gather information from organization 10 through website 120. Templates 48 may allow for required information to be gathered in a standardized format.

Organization 10 may comprise, for example, in whole or in part, a business company, an academic institution, a governmental body, or any other organization. Organization 10 includes individuals that contribute to the implementation of a project, for example, an executive sponsor 112, project owners 114, a project reviewer 116, and an enforcement division 118 of organization 10.

Executive sponsor 112 has a high level of control over a project, but does not manage the day-to-day activities of implementing the project. Executive sponsor 112 may be responsible for gaining approval for a project from an executive team of organization 10, and for generating a contract 44 for implementing an approved project. Executive sponsor 112 may also be responsible for determining whether any corrective action needs to be taken if the execution of a project is not in compliance with the contract. For example, executive sponsor may adjust budget 54 in response to a report that the execution of a project is unsatisfactory.

Project owners 114 are responsible for defining and implementing a project. For example, project owner 114 may define the processes used to implement a project within budget 54 and according to schedule 56 in order to satisfy benefit realization plan 58. Project owner 114 may ensure that the processes are aligned with corresponding processes of other projects, provide tools and support mechanisms for execution of the processes, and identify the roles and responsibilities of individuals executing the processes. Project owner 114 is responsible for the success of the project. If the project is not successful, project owner 114 may be penalized. Multiple project owners 114 may be associated with one project. For example, a successor project owner 114a may take over the responsibility for a project from a predecessor project owner 114b.

Project reviewer 116 monitors a project to determine whether the execution of the project is in compliance with contract 44. Project reviewer 116 may determine whether a project is operating within budget 54 and according to a schedule 56. Project reviewer 116 may also determine whether a project is satisfying benefit realization plan 58.

Enforcement division 118 is responsible for enforcing a penalty that may be imposed for execution of a project that is not in compliance with contract 44. For example, enforcement division 118 may comprise a benefits office that provides benefits to the people of organization 10. In order to encourage compliance with the implementation of a project, benefits to individuals of organization 10 may be withheld. For example, if the implementation of a project is unsatisfactory, a benefits office may reduce compensation or vacation time for project owner 114.

A communication network 22 coupled to organization 10 transmits information between organization 10 and website 120. Communication network may include messaging systems such as telecommunications systems or email systems operating over wired telecommunications, satellite, microwaves, or other suitable wireline or wireless networks, or any combination of the preceding.

Website module 21 provides online communication between organization 10 and processing manager 30, and comprises website 120, security module 124, and interface module 126. Website 120 displays and receives information that aids individuals of organization 10 to implement a project. For example, website 120 may display contract 44 for implementing a project.

Security module 124 may provide, for example, password security, resource access security, and/or system security. Security module 124 may verify passwords individuals of organization 10, for example executive sponsor 112, project owner 114, and project monitor 116. Security module 124 may allow some individuals such as executive sponsor 112 access to parts of website 120, while denying access to other individuals of organization 10. Interface module 126 may comprise a hypertext markup language (HTML) interface that provides instructions to a web browser on how to display website 120.

Processing manager 30 manages retrieving information from database 40 and displaying the information on website 120, and receiving information from website 120 and storing information in database 40. Webserver 132 of processing manager 30 maintains website 120. Webserver 132 may be associated with interface module 126 and security module 124 to provide access and security to processing manager 30. Database management system (DBMS) 134 may be used to manage information in database 40, and may comprise a Microsoft Structured Query Language (SQL) server.

Processing manager 30 may use templates 48 to gather information from organization 10 through website 120. For example, processing manager 30 may display a contract template 48a to executive sponsor 112. Executive sponsor 112 completes contract template 48a to generate contract 44, and submits contract 44 through website 120 to processing manager 30. Processing manager 30 then stores contract 44 in database 40.

Processing manager may also display a monitoring template 48b to project reviewer 116. Project reviewer 116 completes monitoring template 48b to generate a monitoring report 46. Monitoring report 46 is stored in database 40 and may be displayed to executive sponsor 112 through website 120. Processing manager 30 may also display a corrective action template 48c to executive sponsor 112. Executive sponsor 112 completes the corrective action template 48c in order to generate a corrective action request, which is sent to processing manager 30 and stored in database 40.

In summary, project owner 114 agrees in contract 44 to be responsible for implementing a project according to budget 54 and schedule 56, while satisfying benefit realization plan 58. Project reviewer 116 monitors execution of the project to determine compliance with contract 44. If execution of the project is not in compliance with the contract, executive sponsor 112 may perform a corrective action, which may include penalizing project owner 114. Database 40 electronically records the development and execution of the project, and provides a record of reasons for penalizing project owner 114. Consequently, system 8 may provide for an effective and efficient manner for implementing a project in organization 10.

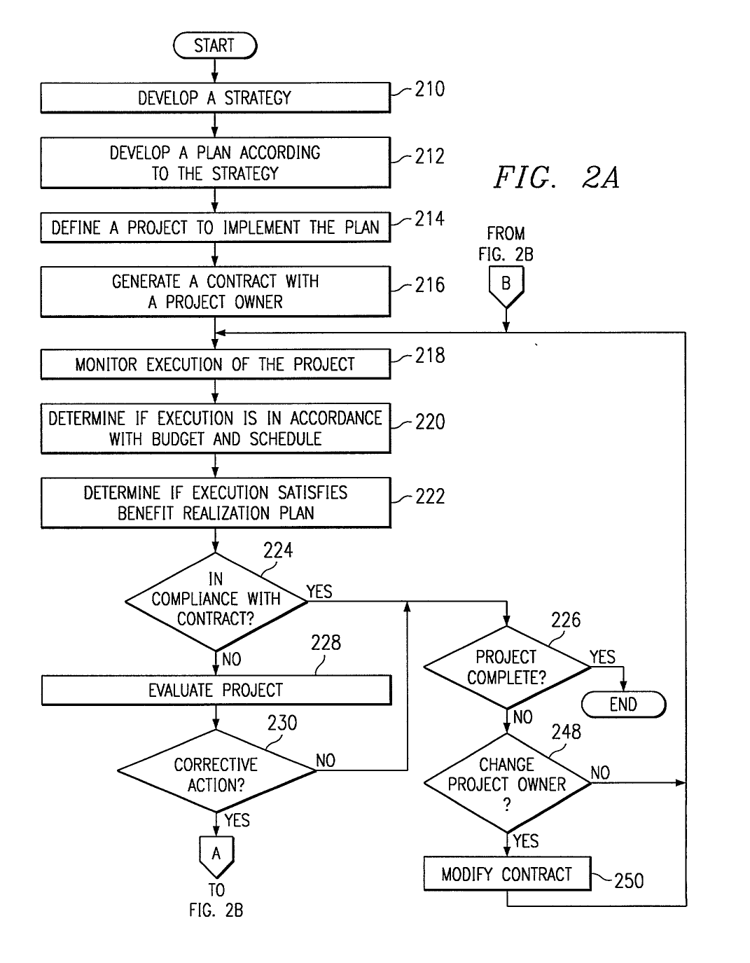

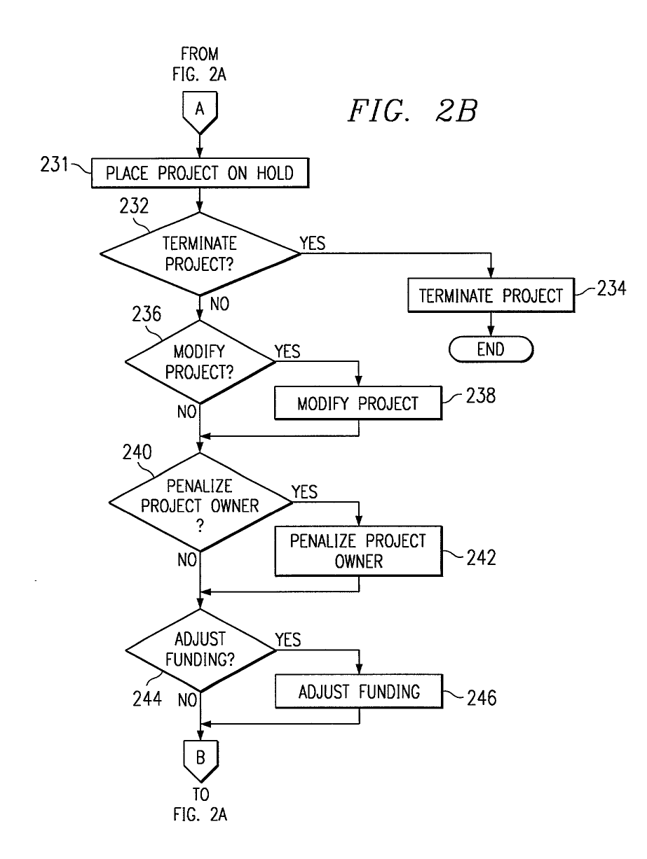

FIG. 2 is a flowchart illustrating one embodiment of a method for implementing a project in organization 10. The method begins at step 210, where a strategy for organization 10 is developed and stored in database 40. The strategy may describe goals that organization 10 may wish to accomplish and potential projects that organization 10 may wish to undertake. Executive sponsor 112 along with an executive team of organization 10 may be responsible for developing the strategy. Executive sponsor 112 may submit a description of the strategy to be saved in strategy file 42 of database 40 using password security access.

At step 212, a plan is developed according to the strategy, and is stored in database 40. The plan may include projects that organization 10 has decided to undertake. Executive sponsor 112 may submit a description of the plan to be saved in plan file 50 of database 40 using password security access.

A project to implement the plan is defined and stored in database 40 at step 214. Project owner 114 may define the project by specifying processes comprising activities needed to complete the project. Project owner 114 may also design budget 54 specifying the funding allotted to implement the project, and schedule 56 defining the timeline and milestones for completion of the project. Project owner 114 may also design benefit realization plan 58 that describes the benefits that a project must deliver. Project owner 114 may submit a description of the project, budget 54, schedule 56, and benefit realization plan 58 to be saved in project file 52 using password security access.

At step 216, a contract 44 is generated between project owner 114 and organization 10, and is stored in database 40. According to contract 44, project owner 114 agrees to be responsible for the implementation of the project. Executive sponsor 112 may prepare contract 44 by completing contract template 48a displayed on website 120. Project owner 114 may electronically sign contract 44, indicating his acceptance of contract 44. Contract 44 stored in database 40 records project owner's agreement to accept responsibility.

Execution of the project is monitored at step 218. Project reviewer 116 may monitor the project by directly observing execution of the project or by reading reports submitting by project owner 114. Project reviewer 116 determines whether the execution of the project is in accordance with budget 54 and schedule 56 within predefined tolerance ranges at step 220. Project reviewer 116 determines whether execution of the project satisfies benefit realization plan 58 within predefined tolerance ranges at step 222. Project reviewer 116 may use monitoring report template 48b displayed on website 120 to generate and submit monitoring report 46, which is stored in database 40.

Project reviewer 116 determines whether execution of the project is satisfactory at step 224. Project reviewer 116 may use the project's compliance with budget 54, schedule 56, and benefit realization plan 58 to determine whether the execution is in compliance with contract 44. If execution of the project is in compliance at step 224, the method proceeds to step 226 to determine whether the project is complete. If execution of the project is not in compliance at step 224, the method proceeds to step 228 to evaluate the project.

Executive sponsor 112 evaluates the project to determine whether any corrective action is required at step 228. Executive sponsor 112 may use monitoring report 46 submitted by project reviewer 116 to make the evaluation. If corrective action is not required at step 230, the method proceeds to step 226 to determine if the project is complete. If corrective action is required at step 230, the method proceeds to step 231 to place the project on hold. Database 40 may modify project file 52 to indicate that the project has been placed on hold and is not executing. The method then proceed to step 232 to determine whether the project has been terminated.

Executive sponsor 112 may terminate the project for a number of reasons. For example, the goals of organization 10 may change, and the project may no longer satisfy the goals. Alternatively, a project may not able to meet the goals of organization 10 within budget 54. When deciding whether to terminate a project, executive sponsor 112 may also consider the costs of terminating the project. For example, the expenses for labor are rarely recoverable. Additionally, resources such as equipment and licenses might not be reusable for other projects, and thus may be non-recoverable expenses. If the project is determined to be terminated at step 232, the project is terminated at step 234, and the method terminates. Project file 52 may reflect the termination by marking the project or contract 44 as terminated. If the project is not terminated at step 232, the method proceeds to step 236 to determine whether to modify the project.

At step 236, executive sponsor 112 may determine whether to modify the project based on whether the modification will maximize the net benefit of the project, that is, the benefits of the project minus the costs of the project. For example, if the modification increase the costs of a project, the net benefit may decrease, unless the modification also sufficiently increases a benefit of the project. If the modification results in a delay in the project, the net benefit may decrease because the time to realize the benefit is shorter. If the modification decreases the scope of the project, the net benefit may go down, unless the discarded parts of the project provide no benefits.

If the project is to be modified at step 236, the method proceeds to step 238 to modify the project. Contract 44 and documents associated with contract 44 may be modified to reflect the project modification. After modification, the method proceeds to step 240 to determine whether to penalize project owner 114. If the project is not to be modified at step 236, the method proceeds directly to step 240.

At step 240, executive sponsor 112 decides whether to penalize project owner 114. If project owner 114 is to be penalized at step 240, the method proceeds at step 242 to penalize project owner 114. A penalty may involve, for example, reduced compensation or reduced vacation time. Penalty file 45 documents a penalty assessed against project owner 114 and reasons for the penalty. Enforcement division 118, for example, a benefits office, may be notified to reduce the benefits for project owner 114. After penalizing the project owner, the method proceeds to step 244 to determine whether to adjust project funding. If project owner 114 is not to be penalized at step 240, the method proceeds directly to step 244.

At step 244, the method determines whether to adjust the funding of the project. Executive sponsor 112 may review the project to determine whether the project remains a good investment. If the project remains a good investment, the funding may be maintained or increased. If, however, the project is not a good investment, funding may be decreased. If the funding is to be adjusted, the method proceeds to step 246 to adjust the funding. Budget 54 may be modified to reflect the funding adjustment. After adjusting the funding, the method returns to step 218 to monitor the execution of the project. If the funding is not to be changed at step 244, the method returns directly to step 218.

At step 226, the method determines whether the project has been completed. Executive sponsor 112 may determine whether the project has accomplished its goals. If the project has been completed at step 226, the method terminates. Project file 52 may record this termination by, for example, marking the project or contract 45 as completed. If the project has not been completed at step 226, the method proceeds to step 246 to determine whether there is a change of project owners 114. For example, a successor project owner 114a may take over the responsibility of implementing a project from a predecessor project owner 114b. If there is a change of project owners 114 at step 246, the method moves to step 248 to modify contract 44 to reflect the change. The method then returns to step 218 to continue monitoring the execution of the project. If there is no change of project owners 114 at step 246, the method returns directly to step 218 to continue monitoring the execution of the project.

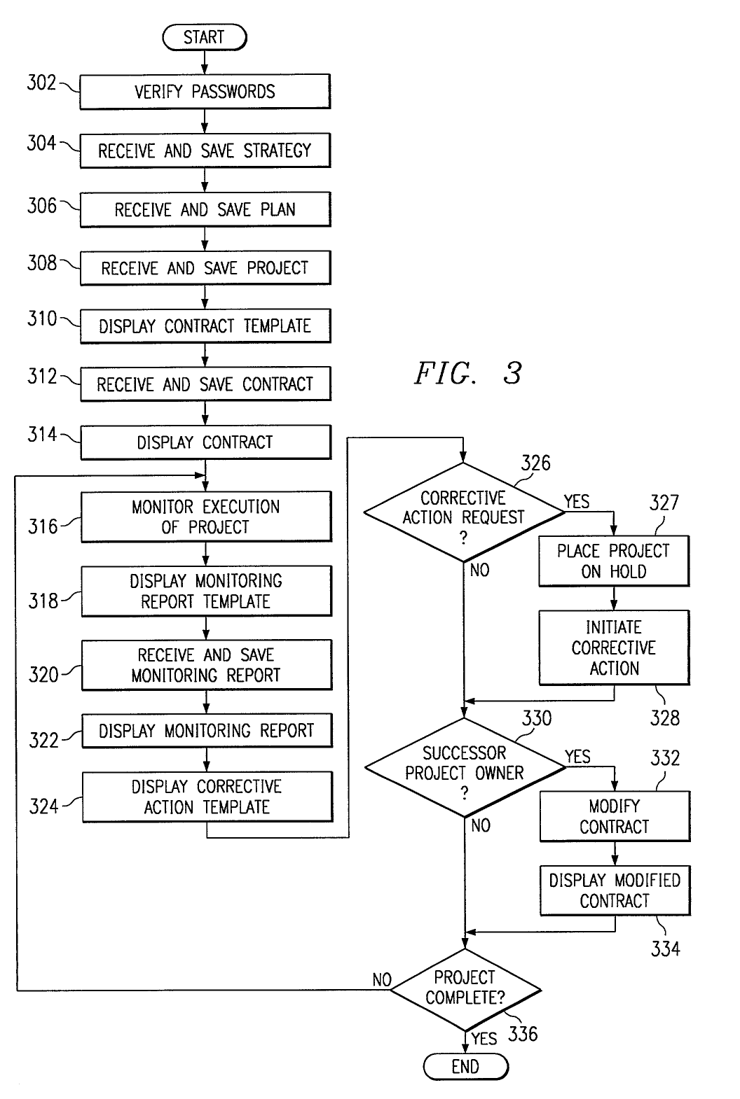

FIG. 3 is a flowchart of one embodiment of a method for implementing a project within organization 10. The method begins at step 302, where processing manager 30 verifies passwords for executive sponsor 112, project owner 114, and project reviewer 116 to ensure that the proper information is received from and displayed to the appropriate individual. A strategy for organization 10 is received from executive sponsor 112 and stored in database 40 at step 304. Executive sponsor 112 may submit a description of the strategy to be saved in strategy file 42 of database 40.

At step 306, a plan is developed according to the strategy, and is stored in database 40. Executive sponsor 112 may submit a description of the plan to be saved in plan file 50 of database 40. Thus, database 40 records the strategy and plan of organization 10. A project to implement the plan is defined and stored in database 40 at step 308. Project owner 114 may submit a description of the project, budget 54, schedule 56, and benefit realization plan 58 to be saved in project file 52. Thus, database 40 records a project of organization 10.

At step 310, contract template 44a is displayed on website 120 to executive sponsor 112. Processing manager 30 retrieves contract template 48a from database 40 and displays contract template 48a on website 120. Executive sponsor 112 completes contract template 48a to generate contract 44, which is displayed on website 120 as an offer to project owner 114. Project owner 114 electronically signs contract 44 to execute contract 44 to accept the agreement. Processing manager 30 receives executed contract 44 and saves contract 44 in database 40 at step 312. Thus, database 40 documents project manager's acceptance of contract 44. Processing manager 30 displays contract 44 on website 120 to individuals of organization 10, for example, project owner 114 and project reviewer 116 at step 314.

Project reviewer 116 monitors the execution of the project at step 316. Processing manager 30 displays a monitoring report template 48b on website 120 to project reviewer 116 at step 318. Project reviewer 116 completes monitoring report template 48b to generate monitoring report 46, which is submitted to processing manager 30. Processing manager 30 receives monitoring report 46 and saves monitoring report 46 in database 40 at step 320. Thus, database 40 records the monitoring of the project. Processing manager 30 displays monitoring report 46 on website 120 to executive sponsor 112 at step 322. A corrective action template is displayed by processing manager 30 on website 120 to executive sponsor 112 at step 324. In response to monitoring report 46, executive sponsor 112 may submit a corrective action request by completing corrective action template 48.

If processing manager 30 receives a corrective action request from executive sponsor 112 at step 326, processing manager places the project on hold at step 327 by marking project file 52 as on hold. Thus, database 40 documents that the project is on hold. Processing manager 40 initiates a corrective action at step 328. A corrective action may involve, for example, penalizing project owner 114. To initiate the corrective action, processing manager 30 may transmit a notification through website 120 to enforcement division 118 to, for example, decrease a benefit to project owner 114 or to terminate the employment of project owner 114. Processing manager 30 may also save the notification to penalty file 45. Thus, database 40 documents the penalty for project owner 114.

Alternatively or additionally, a corrective action may involve modifying or terminating the project. To initiate the corrective action, processing manager may modify contract 44 as saved in database 40 and displayed on website 120 to reflect modification or termination of the project. After initiating the corrective action, the method proceeds to step 330 determine whether there is a successor project owner. If no corrective action request is received at step 326, the method proceeds directly to step 330.

At step 330, the method determines whether there is a successor project owner 114. Successor project owner 114 may result from, for example, reorganization of organization 10 or the termination of the employment of a predecessor project owner 114. If there is a successor project owner 114 at step 330, contract 44 is modified to reflect the successor project owner 114 at step 332. Executive sponsor 112 may complete a new contract template 48a to modify contract 44. Successor project owner 114 signs modified contact 44, and processing manager 30 saves modified contract 44 in database 44 and displays modified contract 44 on website 120 at step 334. After displaying modified contract 44, the method proceeds to step 336 to determine whether the project has been completed. If there is no successor project owner 114 at 330, the method proceeds directly to step 336.

At step 336, the method determines whether the project has been completed. Processing manager 30 checks database 40 to determine whether executive sponsor 112 has determined that the project has been completed. Database 40 may reflect termination of the project by, for example, having project file 52 or contract 44 marked as completed. If the project has been completed, the method terminates. If the project has not been completed, the method returns to step 316 to continue monitoring execution of the project.

Embodiments of the invention may provide numerous technical advantages. A technical advantage of one embodiment is that contract 44 is made between organization 10 and project owner 114, whereby the project owner 114 accepts responsibility for implementation of a project. Contract 44 may include budget 54 and schedule 56 according to which the project must be implemented. Contract 44 may also include benefit realization plan 58 that describes the benefits that the project is expected to deliver. Contract 44 encourages project owner 114 to execute the project in a satisfactory manner.

A technical advantage of another embodiment is that execution of the project is monitored by project reviewer 116. Project reviewer 116 determines whether the project is being executed according to budget 54 and schedule 56, and is satisfying benefit realization plan 58. A technical advantage of another embodiment is that project owner 114 may be penalized if execution of the project is not in compliance with contract 44. Threat of a penalty may encourage project owner 114 to satisfactorily execute the project.

A technical advantage of another embodiment is that database 40 electronically records the development and execution of the project. The record of database 40 may allow organization 10 to analyze how it implements projects. Additionally, database 40 documents the reasons for penalizing project owner 114.

Although an embodiment of the invention and its advantages are described in detail, a person skilled in the art could make various alterations, additions, and omissions without departing from the spirit and scope of the present invention as defined by the appended claims.

What is claimed is:

1. A method for implementing a project in an organization, the method comprising:
receiving a contract representing an agreement between an organization and a project owner, the agreement associated with implementing a project;
storing the contract in a project file of a database;
receiving a monitoring report describing execution of the project in accordance with the contract;
storing the monitoring report in the database;
receiving a corrective action request generated in response to the monitoring report, the corrective action request comprising a request to penalize the project owner;
modifying the project file in response to the corrective action request to indicate that the project is not executing; and
initiating a corrective action in accordance with the corrective action request.

2. The method of claim 1, further comprising:
displaying a contract template on a website; and
receiving the contract generated from the contract template.

3. The method of claim 1, further comprising receiving an electronic signature from the project owner, the electronic signature representing acceptance of the contract.

4. The method of claim 1, further comprising displaying the contract on a website.

5. The method of claim 1, further comprising:
displaying a monitoring report template on a website; and
receiving the monitoring report generated from the monitoring report template.

6. The method of claim 1, further comprising receiving the monitoring report from a project monitor.

7. The method of claim 1, further comprising:
displaying a corrective action template on a website; and
receiving the corrective action request generated from the corrective action template.

8. The method of claim 1 further comprising receiving the corrective action request from an executive sponsor.

9. The method of claim 1, wherein:
the project is associated with a budget and a schedule, the budget and the schedule stored in the database; and
the monitoring report describes whether the execution of the project is in compliance with the budget and the schedule.

10. The method of claim 1, wherein:
the project is associated with a benefit realization plan stored in the database; and
the monitoring report describes whether the execution of the project is in compliance with the benefit realization plan.

11. The method of claim 1, wherein:
the corrective action request comprises a request to modify the contract; and
initiating the corrective action comprises:
modifying the contract; and
saving the modified contract in the database.

12. The method of claim 1, wherein initiating the corrective action comprises transmitting the request to penalize to an enforcement division of the organization to implement a penalty.

13. The method of claim 1, wherein:
the corrective action request comprises a request to terminate the project;
initiating the corrective action comprises modifying the contract to reflect a termination of the project; and
saving the modified contract in the database.

14. The method of claim 1, further comprising:
determining that there is a successor project owner;
modifying the contract in the database in response to the determination; and
saving the modified contract in the database.

15. A system for implementing a project in an organization, the system comprising:
a database operable to store data; and
a processing manager coupled to the database and operable to:
receive a contract representing an agreement between an organization and a project owner, the agreement associated with implementing a project;
store the contract in a project file of the database;
receive a monitoring report describing execution of the project in accordance with the contract;
store the monitoring report in the database;
receive a corrective action request generated in response to the monitoring report, the corrective action request comprising a request to penalize the project owner;
modify the project file in response to the corrective action request to indicate that the project is not executing; and
initiate a corrective action in accordance with the corrective action request.

16. The system of claim 15, wherein the processing manager is operable to:
display a contract template on a website; and
receive the contract generated from the contract template.

17. The system of claim 15, wherein the processing manager is operable to receive an electronic signature from the project owner, the electronic signature representing acceptance of the contract.

18. The system of claim 15, wherein the processing manager is operable to display the contract on a website.

19. The system of claim 15, wherein the processing manager is operable to:
display a monitoring report template on a website; and
receive the monitoring report generated from the monitoring report template.

20. The system of claim 15, wherein the processing manager is operable to receive the monitoring report from a project monitor.

21. The system of claim 15, wherein the processing manager is operable to:
display a corrective action template on a website; and
receive the corrective action request generated from the corrective action template.

22. The system of claim 15, wherein the processing manager is operable to receive the corrective action request from an executive sponsor.

23. The system of claim 15, wherein:
the project is associated with a budget and a schedule, the budget and the schedule stored in the database; and
the monitoring report describes whether the execution of the project is in compliance with the budget and the schedule.

24. The system of claim 15, wherein:
the project is associated with a benefit realization plan stored in the database; and
the monitoring report describes whether the execution of the project is in compliance with the benefit realization plan.

25. The system of claim 15, wherein:
the corrective action request comprises a request to modify the contract; and
the processing manager is operable to:
modify the contract; and
save the modified contract in the database.

26. The system of claim 15, wherein the processing manager is operable to transmit the request to penalize to an enforcement division of the organization to implement a penalty.

27. The system of claim 15, wherein:
the corrective action request comprises a request to terminate the project;
the processing manager is operable to:
modify the contract to reflect a termination of the project; and
save the modified contract in the database.

28. The system of claim 15, wherein the processing manager is operable to:
determine that there is a successor project owner;
modify the contract in the database in response to the determination; and
save the modified contract in the database.

29. A method for implementing a project in an organization, the method comprising:
defining a project associated with a project owner;
generating a contract between an organization and the project owner, the contract associated with implementing the project;
monitoring execution of the project;
determining whether the execution is in compliance with the contract in response to the monitoring; and
determining a corrective action if the execution is not in compliance with the contract, the corrective action comprising penalizing the project owner.

30. The method of claim 29, wherein determining whether the execution is in compliance comprises determining whether the execution is in compliance with a benefit realization plan associated with the project.

31. The method of claim 29, wherein determining whether the execution is in compliance comprises determining whether the execution is in compliance with a schedule associated with the project.

32. The method of claim 29, wherein determining whether the execution is in compliance comprises determining whether the execution is in compliance with a budget associated with the project.

33. The method of claim 29, further comprising:
determining that there is a successor project owner; and
passing the contract to the successor project owner.

34. The method of claim 29, wherein the corrective action comprises withholding a benefit from the project owner.

35. The method of claim 29, wherein the corrective action comprises modifying the project.

36. The method of claim 29, wherein the corrective action comprises adjusting a budget associated with the project.

37. The method of claim 29, wherein the corrective action comprises terminating the project.
